(19) United States
(12) Patent Application Publication
(10) Pub. No.: US 2026/0061678 A1
(43) Pub. Date: Mar. 5, 2026

(54) IN-MOLD COATING INJECTION DEVICE AND IN-MOLD COATING INJECTION METHOD USING THE SAME

(71) Applicant: SEIKOH GIKEN Co., Ltd., Matsudo-shi (JP)

(72) Inventors: Norihiro KAKINUMA, Matsudo-shi (JP); Masami SUZUKI, Matsudo-shi (JP); Kenichi TANAKA, Matsudo-shi (JP)

(21) Appl. No.: 19/386,226

(22) Filed: Nov. 12, 2025

Related U.S. Application Data
(63) Continuation of application No. PCT/JP2025/000131, filed on Jan. 7, 2025.

(30) Foreign Application Priority Data
Jan. 23, 2024 (JP) 2024-007911

(51) Int. Cl. B29C 45/16; B29K 101/10

(52) U.S. Cl. CPC B29C 45/1679; B29K 2101/10; B29K 2995/0015

(57) ABSTRACT

An in-mold coating injection device 1 for injecting a thermosetting liquid coating agent 4 into a coating gap 13 between an outer surface of a molding base material 3 held inside upper and lower molds 2b, 2a which are heated and an inner surface of the upper mold 2b, the in-mold coating injection device 1 including: an injection machine 8 having an injection port 6 and a tip valve portion 7d of an opening/closing valve 7 for opening and closing the injection port 6 at a tip portion 8a for injecting the thermosetting liquid coating agent 4 ejected from the injection port 6 into the coating gap 13; and a heat insulation layer 9 provided between the tip portion 8a of the injection machine 8 and the upper mold 2b and made of a material having a thermal conductivity lower than that of a material of the tip portion 8a.

### CROSS-REFERENCE TO RELATED APPLICATIONS

This application claims the benefit of priority and is a Continuation application of the prior International Patent Application No. PCT/JP2025/000131, with an international filing date of Jan. 7, 2025, which designated the United States, and is related to the Japanese Patent Application No. 2024-007911, filed Jan. 23, 2024, the entire disclosures of all applications are expressly incorporated by reference in their entirety herein.

### TECHNICAL FIELD

The present invention relates to an in-mold coating injection device and an in-mold coating injection method using the same for injecting a thermosetting liquid coating agent between a molding base material held inside a heated mold and an inner surface of the mold.

### BACKGROUND OF THE INVENTION

In recent years, with increasing awareness of environmental issues, an in-mold coating method (in-mold coating: IMC) has gained attention as an alternative coating technology without using organic solvent and having a high carbon dioxide emission reduction effect. The IMC is the technology of pressing the other mold against one mold holding a molding base material so as to cover the molding base material, injecting a liquid coating agent into a coating gap formed between an inner surface of the other mold and an outer surface of the molding base material, and solidifying the liquid coating agent by heating to form a coating film on the outer surface of the molding base material.

As for the characteristics of the IMC, the following characteristics can be listed, for example. (1) The IMC is friendly to the environment and the human body since organic solvent used in general spray coating is not used. (2) The equipment for the coating process (spray application, oven heat treatment) is not required. (3) The waste can be extremely reduced since the coating composition is not diluted with organic solvent and the rate (coating efficiency) of the material (coating composition) formed on the outer surface of the molding base material is extremely high. The IMC is used for improving the quality of the surface of the molded article and simplifying the coating process. In particular, the IMC is widely used for the exterior components or the like in the automobile industry where the outer appearance and quality are highly demanded.

As for the above-mentioned liquid coating agent, thermosetting resin in which non-resin substances (e.g., metal or inorganic substances with fine particle size) having various functional characteristics are blended and dispersed is often used in order to impart functional characteristics lacking in the material (e.g., thermoplastic resin) of the molding base material which is the material to be coated. In the above described thermosetting liquid coating agent, the thermosetting resin contained as the main component is cured by chemical reaction due to the heat from the mold and is coated on the outer surface of the molding base material. As an in-mold coating injection device for injecting the above described thermosetting liquid coating agent into the mold internally holding the molding base material as a material to be coated, a device shown in FIGS. 1A, 1B, 1C and 1D is known (shown in Patent Document 1).

In an in-mold coating injection device a, in a state that one mold b and another mold c are butted together to form a molding space f between a cavity d and a core e as shown in FIG. 1A, a molding material h (e.g., thermoplastic resin) is injected from a sprue g into the molding space f to mold a molding base material i as shown in FIG. 1B, and immediately after that a thermosetting liquid coating agent j is injected as a coating agent at a predetermined pressure to the inner surface of the cavity d as shown in FIG. 1C, and the injected thermosetting liquid coating agent j penetrates between the inner surface of the cavity d and the outer surface of the molding base material i and cures to form a coating on the outer surface of the molding base material i as shown in FIG. 1D.

As shown in FIG. 1A, the in-mold coating injection device a includes a cylinder k provided so as to connect to the inner surface of the cavity d in one mold b, a rod-shaped piston l that freely moves up and down inside the cylinder k, and a hydraulic actuator m that moves the rod-shaped piston l up and down. The in-mold coating injection device a also includes a storage chamber n partitioned so as to connect to an upper part of the cylinder k, an introduction path o for introducing the thermosetting liquid coating agent j as a coating material into the storage chamber n, a discharge path p for discharging the thermosetting liquid coating agent j from the storage chamber n, and an external circulation line (not illustrated) connecting the discharge path o and the introduction path p. The thermosetting liquid coating agent j is returned from the discharge path p to the introduction path o via the circulation line to circulate the thermosetting liquid coating agent j in the storage chamber n. Thus, the thermosetting liquid coating agent j in the storage chamber n is prevented from curing due to the heat from the mold b.

The molding process and coating process of the molding base material i using the above described in-mold coating injection device a will be explained. First, as shown in FIG. 1A, the rod-shaped piston l is lowered to a position where the lower end surface of the rod-shaped piston l is flush with the cavity d, and a part of the molding space f is partitioned by the lower end surface of the rod-shaped piston l. In the above described state, as shown in FIG. 1B, the molding material h (e.g., thermoplastic resin) is injected from the sprue g into the molding space f to mold the molding base material i. The molding base material i receives heat from the mold b which is heated to a high temperature state, and plasticity (soft state) is maintained for a certain period of time.

Immediately after molding the molding base material i, the rod-shaped piston l is raised above the storage chamber n as shown in FIG. 1C, the thermosetting liquid coating agent j introduced from the introduction path o into the storage chamber n is guided to the cylinder k, the rod-shaped piston l is lowered as shown in FIG. 1D, and the thermosetting liquid coating agent j in the cylinder k is injected between the inner surface of the cavity d and the outer surface of the molding base material i at a predetermined pressure. The injected thermosetting liquid coating agent j penetrates between the inner surface of the cavity d and the outer surface of the molding base material i, and cures by chemical reaction due to the heat from the mold b. Thus, a coating is formed on the outer surface of the molding base material i.

### PRIOR ART DOCUMENT

### Patent Documents

[Patent Document 1] Japanese Patent No. 3422843

### SUMMARY OF THE INVENTION

### Problem to be Solved by the Invention

In the above-mentioned conventional in-mold coating injection device a, as shown in FIGS. 1A to 1D, the rod-shaped piston l moves up and down inside the cylinder k to inject the thermosetting liquid coating agent j into the cavity d of the mold b. Thus, an extremely narrow clearance (gap) is required between the cylinder k and the rod-shaped piston l to allow sliding between the cylinder k and the rod-shaped piston l.

Therefore, in a state that the rod-shaped piston l is lowered and inserted into the cylinder k as shown in FIGS. 1A and 1B, the thermosetting liquid coating agent j in the storage chamber n, penetrates into the clearance between the cylinder k and the rod-shaped piston l although in a very small amount and the thermosetting liquid coating agent j cures due to the heat from the mold b which is heated to a high temperature. As a result, a cured layer is formed by the cured thermosetting liquid coating agent j in the clearance between the cylinder k and the rod-shaped piston l. The above described cured layer adheres to the inner surface of the cylinder k or the outer surface of the rod-shaped piston l.

When the cured layer of the thermosetting liquid coating agent j formed in the clearance between the cylinder k and the rod-shaped piston l adheres to the inner surface of the cylinder k, the cured layer is scraped off by the edge of the lower end surface of the rod-shaped piston l when the rod-shaped piston l is lowered as shown in FIG. 1D after the rod-shaped piston l is raised as shown in FIG. 1C. Thus, fragments of the scraped-off cured layer enter between the cavity d and the molding base material i as contamination (impurity, foreign matter). When the fragments of the cured layer appear on the product surface, it results in appearance defects. When the fragments of the cured layer exist at the interface between the molding base material and the coating, the fragments become starting points for interface delamination, impairing adhesion and resulting in defective products.

When the cured layer of the thermosetting liquid coating agent j formed in the clearance between the cylinder k and the rod-shaped piston l adheres to the outer surface of the rod-shaped piston l, the cured layer is scraped off by the edge of a guide hole q formed in the ceiling surface of the storage chamber n to guide the rod-shaped piston l when the rod-shaped piston l in the lowered state as shown in FIG. 1B is raised as shown in FIG. 1C. Thus, the fragments of the scraped-off cured layer enter into the thermosetting liquid coating agent j in the storage chamber n. The scraped-off fragments of the cured layer are discharged from the storage chamber n via the discharge path p together with the thermosetting liquid coating agent j, enter into the external circulation line (not illustrated) and return to the storage chamber n through the introduction path o. Therefore, the thermosetting liquid coating agent j mixed with the scraped-off fragments of the cured layer circulate after that. The scraped-off fragments of the cured layer in the storage chamber n are injected between the cavity d and the molding base material i together with the thermosetting liquid coating agent j as the rod-shaped piston l descends as shown in FIG. 1D. Thus, the problems described above are caused.

The purpose of the present invention invented by considering the above described situations is to provide an in-mold coating injection device and an in-mold coating injection method using the same for injecting a thermosetting liquid coating agent between an outer surface of a molding base material held inside a mold which is heated and an inner surface of the mold for reducing the heat received by the thermosetting liquid coating agent from the mold before injection from the injection machine to the mold, suppressing the curing reaction to prevent the contamination and achieving a stable injection state.

### Means for Solving the Problems

The present invention invented for achieving the above described purposes provides an in-mold coat injection device for injecting a thermosetting liquid coating agent between an outer surface of a molding base material held inside a mold which is heated and an inner surface of the mold, the in-mold coat injection device including: an injection machine having an injection port and an opening/closing valve for opening and closing the injection port at a tip portion, the injection machine being configured to inject the thermosetting liquid coating agent ejected from the injection port between the outer surface of the molding base material and the inner surface of the mold; and a heat insulation layer provided between the tip portion of the injection machine and the mold, the heat insulation layer being made of a material having a thermal conductivity lower than that of a material of the tip portion.

In the in-mold coat injection device of the present invention, the injection machine may be provided with a cooling mechanism to prevent the thermosetting liquid coating agent inside the injection machine from curing.

In the in-mold coat injection device of the present invention, the tip portion of the injection machine may have an outer circumferential surface configured to be inserted into a mounting hole formed in the mold and a tip surface provided with the injection port, and the heat insulation layer may be provided on the outer circumferential surface of the tip portion so as to contact an inner circumferential surface of the mounting hole.

In the in-mold coat injection device of the present invention, a thermal conductivity of the heat insulation layer may be lower than a thermal conductivity of the mold.

In the in-mold coat injection device of the present invention, the heat insulation layer may be a thermal spray layer.

In the in-mold coat injection device of the present invention, the thermal spray layer may be a ceramic thermal spray layer formed by thermally spraying ceramics.

In the in-mold coat injection device of the present invention, a flange portion may be provided on the outer circumferential surface of the tip portion of the injection machine so as to be positioned closer to the tip surface than the heat insulation layer provided on the outer circumferential surface, an outer diameter of an edge portion of the flange portion may be smaller than an outer diameter of a surface of the heat insulation layer, and a gap may be formed between the edge portion of the flange portion and the mounting hole of the mold.

In the in-mold coat injection device of the present invention, the heat insulation layer may be porous.

The present invention also provides an in-mold coating injection method for injecting the thermosetting liquid coating agent between the outer surface of the molding base material and the inner surface of the mold using the above described in-mold coating injection device, wherein a heat of the mold is transmitted to the tip portion of the injection machine via the heat insulation layer to suppress a heat transfer from the mold to the tip portion of the injection machine, and a curing reaction of the thermosetting liquid coating agent in a vicinity of the injection port arranged at the tip portion of the injection machine and the opening/closing valve for opening and closing the injection port is suppressed.

The present invention also provides an in-mold coating injection method for injecting the thermosetting liquid coating agent between the outer surface of the molding base material and the inner surface of the mold using the above described in-mold coating injection device, wherein a part of the thermosetting liquid coating agent ejected from the injection port of the injection machine enters the gap between the mounting hole of the mold and the edge portion of the flange portion of the injection machine, and the thermosetting liquid coating agent entered the gap cures due to a heat from the mold for preventing the thermosetting liquid coating agent ejected from the injection port from penetrating into the heat insulation layer through the gap.

### Effects of the Invention

The in-mold coat injection device and the in-mold coating injection method using the same of the present invention have the following effects.

(1) In an in-mold coating injection device for injecting a thermosetting liquid coating agent between an outer surface of a molding base material held inside a mold which is heated and an inner surface of the mold, the in-mold coat injection device includes: an injection machine having an injection port and an opening/closing valve for opening and closing the injection port at a tip portion, the injection machine being configured to inject the thermosetting liquid coating agent ejected from the injection port between the outer surface of the molding base material and the inner surface of the mold; and a heat insulation layer provided between the tip portion of the injection machine and the mold, the heat insulation layer being made of a material having a thermal conductivity lower than that of a material of the tip portion. Therefore, the heat of the mold is transmitted to the tip portion of the injection machine via the heat insulation layer, and the heat transfer from the mold to the tip portion of the injection machine is suppressed. Thus, the heat received by the thermosetting liquid coating agent from the mold in the vicinity of the injection port arranged at the tip portion and the opening/closing valve for opening and closing the injection port can be reduced.

(2) As a result, the curing reaction of the thermosetting liquid coating agent in the vicinity of the injection port of the injection machine and the opening/closing valve for opening and closing the injection port (i.e., the curing reaction of the thermosetting liquid coating agent before injection) is suppressed. Thus, the contamination can be prevented and a stable injection state can be achieved.

### BRIEF DESCRIPTION OF DRAWINGS

FIGS. 1A to 1D are explanatory diagrams of an in-mold coating injection device and an in-mold coating injection method using the same showing a conventional example. FIG. 1A shows a process before molding a molding base material. FIG. 1B shows a molding process of the molding base material. FIG. 1C shows a process before injecting a coating agent. FIG. 1D shows an injection process of the coating agent.

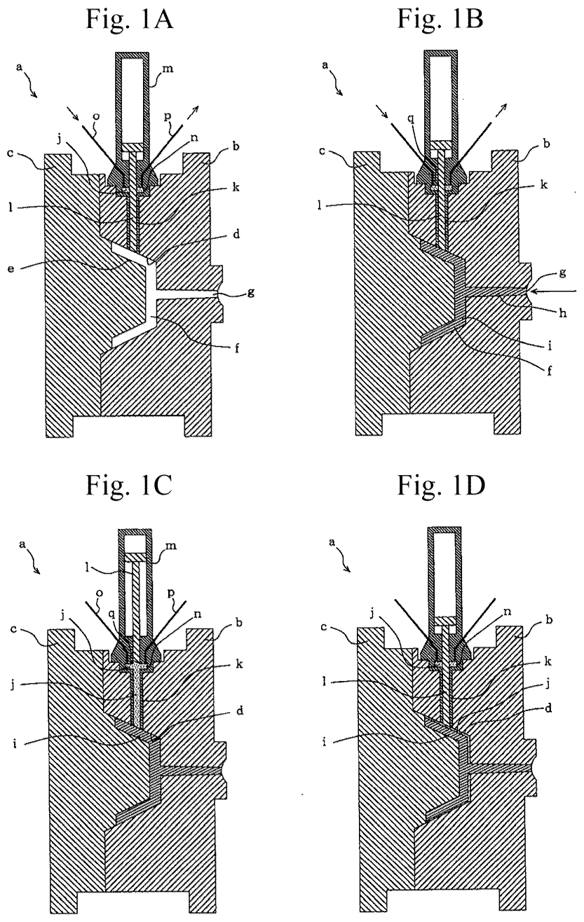

FIG. 2 is a cross-sectional view showing the entire system of the in-mold coating injection device according to an embodiment of the present invention.

FIG. 3 is a cross-sectional view showing an injection port, an opening/closing valve and a heat insulation layer of a tip portion of an injection machine of the in-mold coating injection device of FIG. 2.

FIGS. 4A and 4B are explanatory diagrams showing a cooling mechanism provided in the injection machine of the in-mold coating injection device of FIG. 2. FIG. 4A is a transparent perspective view. FIG. 4B is a cross-sectional view.

FIG. 5 is a cross-sectional view when a filling of the thermosetting liquid coating agent into the injection machine of the in-mold coating injection device of FIG. 2 is started.

FIG. 6 is a cross-sectional view when the filling of the thermosetting liquid coating agent into the injection machine is completed following FIG. 5.

FIG. 7 is a cross-sectional view when an injection of the thermosetting liquid coating agent filled in the injection machine from the injection port to between the outer surface of the molding base material and the inner surface of the mold is started following FIG. 6.

FIG. 8 is a cross-sectional view when the injection of the thermosetting liquid coating agent is completed following FIG. 7.

FIGS. 9A to 9C are an explanatory diagrams showing a modification of the present invention. FIG. 9A is a cross-sectional view showing a tip portion of an injection machine of an in-mold coating injection device according to the modification. FIG. 9B is a cross-sectional view showing a state that curable liquid coating agent entered a gap between an edge of a flange portion provided at the tip portion and a mounting hole of a mold cures due to the heat from the mold. FIG. 9C is a partially enlarged view of FIG. 9B.

FIGS. 10A to 10C are cross-sectional views showing manufacturing processes of a flange portion and a heat insulation layer of the tip portion of the injection machine according to the modification shown in FIG. 9A. FIG. 10A shows the first process, FIG. 10B shows the second process and FIG. 9C shows the third process.

### DETAILED DESCRIPTION OF THE INVENTION

Hereafter, the preferable embodiments of the present invention will be explained in detail with reference to the attached drawings. The dimensions, materials, other specific values and the like shown in the embodiments are merely examples for facilitating the understanding of the invention. These do not limit the present invention unless particularly mentioned. Note that the repeated explanation of the elements having substantially same functions and configurations is omitted in the specification and drawings by adding the same reference numeral. In addition, the illustration of the elements not directly related to the present invention is omitted.

(Overview of in-Mold Coat Injection Device 1)

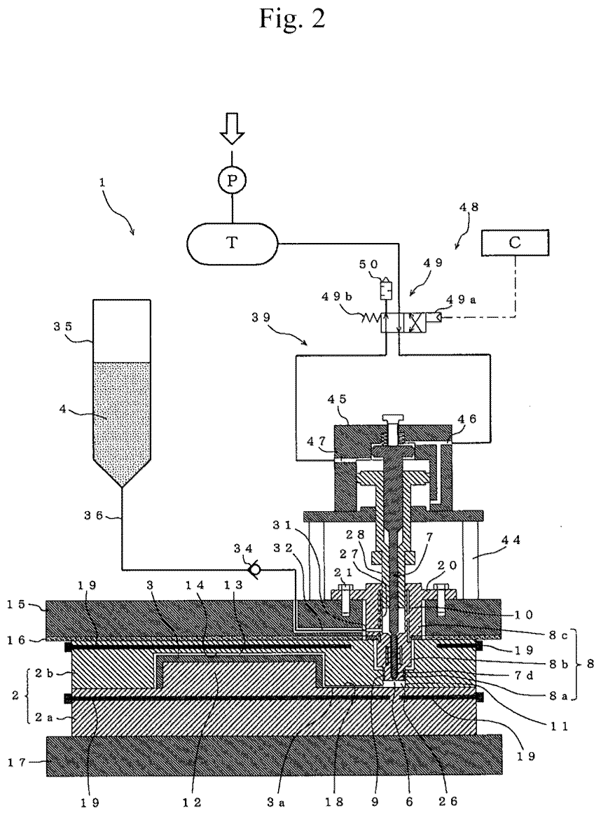

As shown in FIG. 2, an in-mold coating injection device 1 according to an embodiment of the present invention is configured to inject a thermosetting liquid coating agent 4 between an outer surface of a molding base material 3 held inside a mold 2 which is heated and an inner surface of the mold 2. The in-mold coating injection device 1 includes an injection machine 8 and a heat insulation layer 9. The injection machine 8 has an injection port 6 and an opening/closing valve 7 (tip valve portion 7d) for opening and closing the injection port 6 at a tip portion 8a. The injection machine 8 is configured to inject the thermosetting liquid coating agent 4 ejected from the injection port 6 between the outer surface of the molding base material 3 and the inner surface of the mold 2. The heat insulation layer 9 is provided between the tip portion 8a of the injection machine 8 and the mold 2. The heat insulation layer 9 is made of a material having a thermal conductivity lower than that of a material of the tip portion 8a.

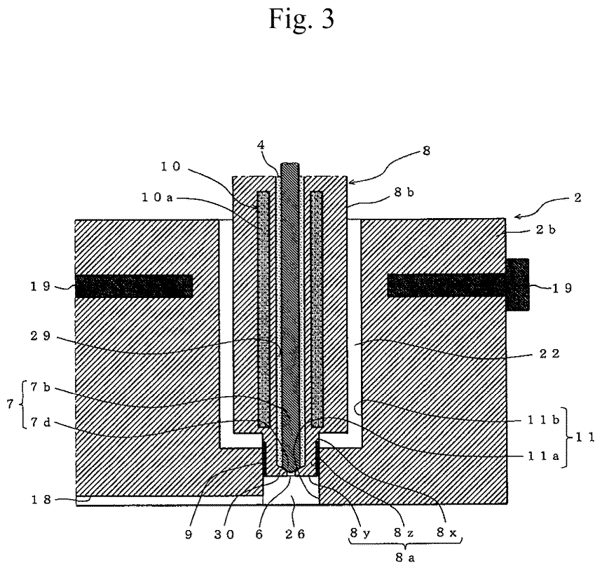

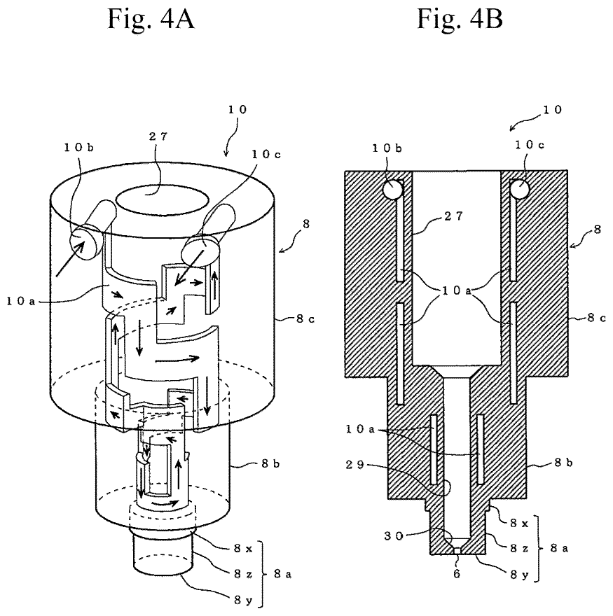

As shown in FIGS. 3, 4A and 4B, the injection machine 8 is provided with a cooling mechanism 10 to prevent the thermosetting liquid coating agent 4 inside the injection machine 8 from curing. The tip portion 8a of the injection machine 8 has an outer circumferential surface 8x inserted into a tip hole portion 11a of a mounting hole 11 formed in the mold 2 and a tip surface 8y provided with the injection port 6. The heat insulation layer 9 is provided on the outer circumferential surface 8x of the tip portion 8a so as to contact the inner circumferential surface of the mounting hole 11. The thermal conductivity of the heat insulation layer 9 is lower than the thermal conductivity of the material of the mold 2. The heat insulation layer 9 is composed of a thermal spray layer. As the heat insulation layer 9, a ceramic thermal spray layer formed by thermally spraying ceramics is used. Hereafter, each component will be explained.

### (Mold 2)

As shown in FIG. 2, the mold 2 is composed of one mold 2a (hereinafter also referred to as lower mold 2a) and another mold 2b (hereinafter also referred to as upper mold 2b) arranged opposite to the one mold 2a. The lower mold 2a is provided with a convex core 12 to which a separately molded molding base material 3 is attached. The upper mold 2b is provided with a cavity 14 recessed so that a predetermined coating gap 13 (e.g., 50 μm to 100 μm) is formed between the cavity 14 and the outer surface of the molding base material 3 attached to the core 12 of the lower mold 2a. The upper mold 2b is attached to a lower surface of an upper platen 15 via a heat insulation plate 16 with bolts (not illustrated). The lower mold 2a is attached to an upper surface of a lower platen 17 with bolts (not illustrated). The lower platen 17 is moved in the up-down direction relative to the upper platen 15. Thus, the lower mold 2a approaches to and separates from the upper mold 2b for mold clamping and mold opening.

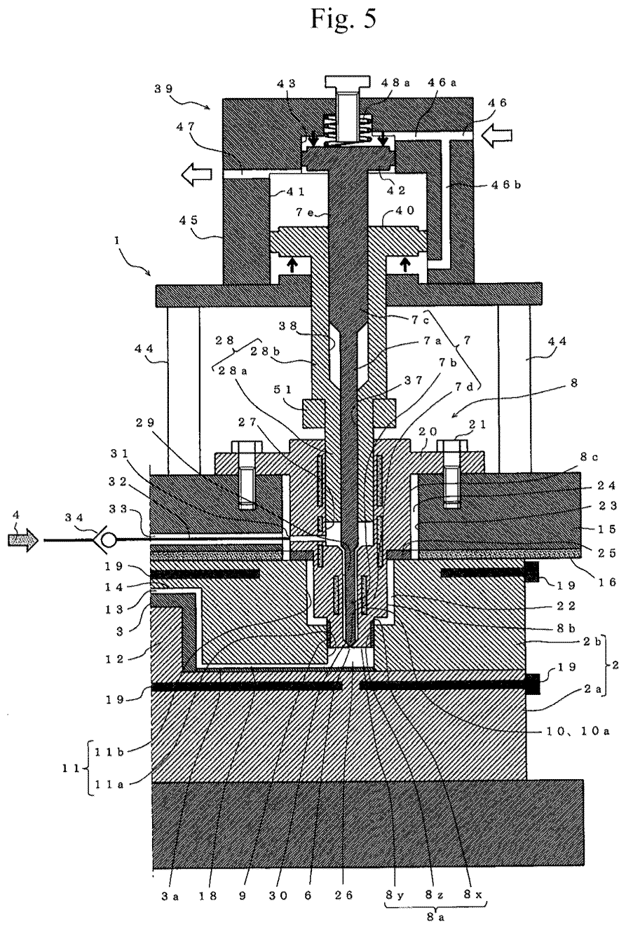

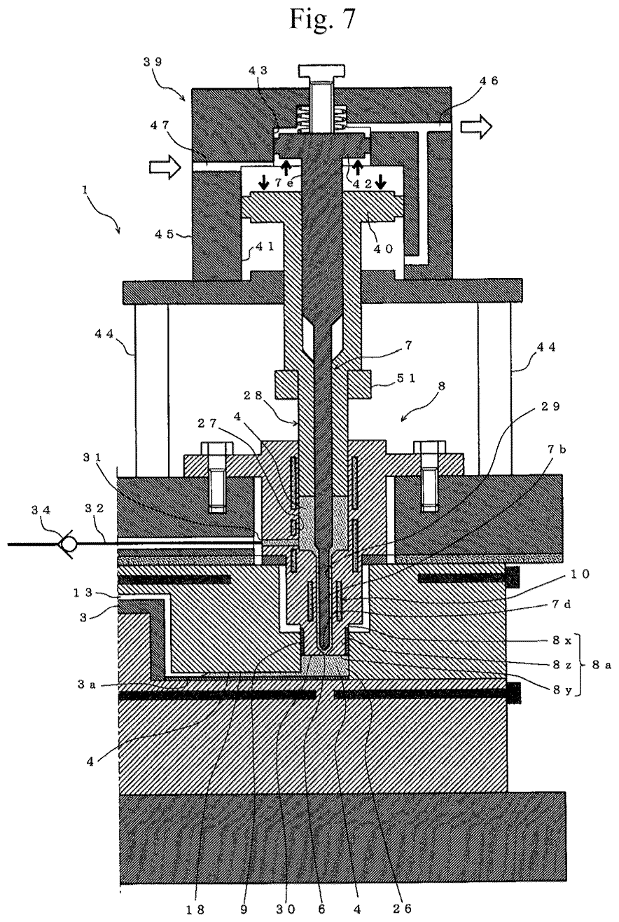

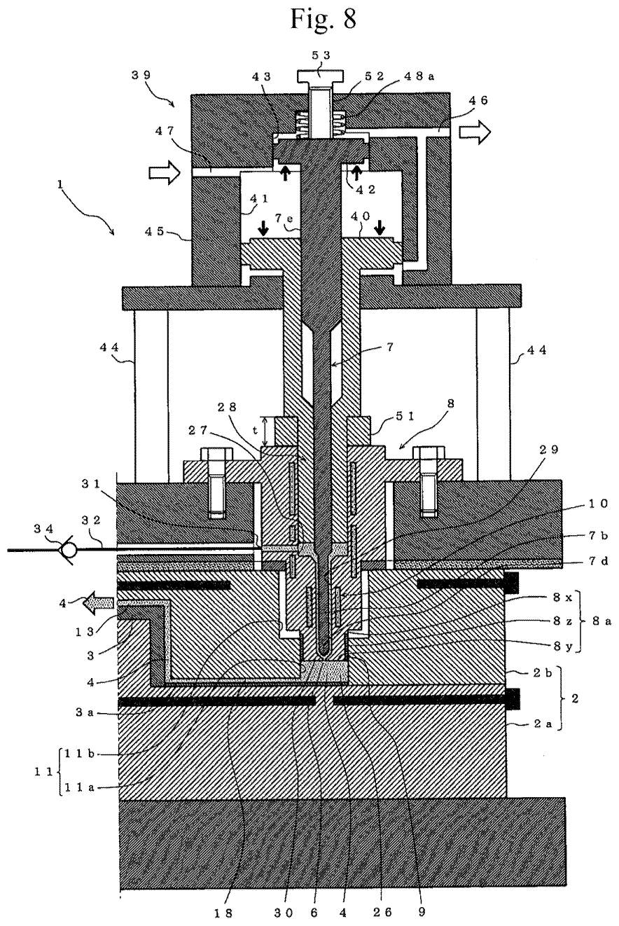

As shown in FIGS. 2 and 5, a runner groove 18 is formed on the abutting surface (parting surface) of the upper mold 2b with the lower mold 2a to supply the thermosetting liquid coating agent 4 (e.g., one-component curing type thermosetting coating composition, hereinafter also simply referred to as coating composition) to the coating gap 13 between the outer surface of the molding base material 3 and the inner surface of the cavity 14 of the upper mold 2b during mold clamping. The runner groove 18 accommodates a runner 3a which is generated when the molding base material 3 is molded by another molding mold (not illustrated) instead of the upper mold 2b. The coating composition 4 is ejected from the injection port 6 of the injection machine 8, passes through the runner groove 18 and is injected into the coating gap 13 along the runner 3a as shown in FIGS. 7 and 8.

As shown in FIGS. 2 and 5, the upper mold 2b is provided with a heating mechanism 19 to heat and cure the coating composition 4 injected into the coating gap 13 through the runner groove 18. For example, an electric heating wire (electric resistance wire) that generates heat when energized is used as the heating mechanism 19. The heating mechanism 19 (electric heating wire) is arranged near the ceiling surface of the cavity 14 that partitions the coating gap 13. The heating mechanism 19 is also provided in the lower mold 2a. The heating mechanism 19 of the lower mold 2a prevents the upper mold 2b from being cooled by the lower mold 2a when the lower mold 2a is butted against the upper mold 2b during mold clamping, and suppresses temperature decrease in the coating gap 13. In addition, the heat insulation plate 16 interposed between the upper mold 2b and the upper platen 15 functions to suppress the heat of the upper mold 2b from being transmitted to the upper platen 15. Because of this, the heat input from the upper platen 15 to the injection machine 8 is reduced, and the progress of the curing reaction of the coating composition 4 guided into the inside of the injection machine 8 is suppressed.

### (Injection Machine 8)

As shown in FIGS. 2 and 5, when the lower mold 2a holding the molding base material 3 on the core 12 is pressed against the upper mold 2b, a predetermined (e.g., 50 μm to 100 μm) coating gap 13 is formed between the inner surface of the cavity 14 of the upper mold 2b and the outer surface of the molding base material 3. The upper mold 2b is equipped with the injection machine 8 to inject a predetermined amount of the coating composition 4 corresponding to the volume of the space of the coating gap 13 into the coating gap 13. The tip portion 8a of the injection machine 8 is provided with the injection port 6 for injecting the coating composition 4 into the coating gap 13 and the opening/closing valve 7 (tip valve portion 7d) for opening and closing the injection port 6. The tip portion 8a of the injection machine 8 has the outer circumferential surface 8x and the tip surface 8y. The outer circumferential surface 8x is inserted into the tip hole portion 11a of the mounting hole 11 formed in the upper mold 2b. The tip surface 8y is provided with the injection port 6. The heat insulation layer 9 is provided on the outer circumferential surface 8x of the tip portion 8a so as to contact the inner circumferential surface of the tip hole portion 11a of the mounting hole 11.

As shown in FIG. 2, the injection machine 8 has a three-stage cylindrical body in which a small-diameter tip portion 8a, a medium-diameter portion 8b larger in diameter than the small-diameter tip portion, and a large-diameter portion 8c larger in diameter than the medium-diameter portion are connected from bottom to top. A mounting flange 20 is provided on the outer circumferential surface of the large-diameter portion 8c. The mounting flange 20 is attached to the upper platen 15 by bolts 21. As shown in FIG. 5, the upper mold 2b is formed with the mounting hole 11 penetrating the upper and lower surfaces to accommodate the injection machine 8. The mounting hole 11 consists of a tip hole portion 11a having a hole diameter corresponding to the tip portion 8a of the injection machine 8, and a medium-diameter hole portion 11b having a hole diameter larger than the medium-diameter portion 8b of the injection machine 8. The tip hole portion 11a is connected to the runner groove 18 via a coating agent reservoir portion 26. A predetermined interval 22 is formed between the medium-diameter hole portion 11b and the medium-diameter portion 8b. The interval 22 functions as an air heat insulation layer that suppresses the heat of the upper mold 2b from being transmitted to the injection machine 8.

As shown in FIG. 5, the upper platen 15 is formed with a through hole 23 having a hole diameter larger than the large-diameter portion 8c to accommodate the large-diameter portion 8c of the injection machine 8. A gap 24 is formed between the through hole 23 and the large-diameter portion 8c of the injection machine 8. The gap 24 functions as an air heat insulation layer that suppresses the heat transmitted from the upper mold 2b to the upper platen 15 via the heat insulation plate 16 from being transmitted to the injection machine 8 although in a small amount.

As shown in FIG. 5, a heat insulation ring 25 is interposed between the step formed from the large-diameter portion 8c to the medium-diameter portion 8b of the injection machine 8 and the upper surface of the upper mold 2b to suppress the heat of the upper mold 2b from being transmitted to the injection machine 8. The heat insulation ring 25 suppresses the heat of the upper mold 2b from being transmitted to the injection machine 8, and functions to suppress the coating composition 4 guided into the inside of the injection machine 8 from receiving the heat from the upper mold 2b and suppress the progressing in curing reaction. In addition, the heat insulation ring 25 is slightly crushed when the heat insulation ring 25 is sandwiched between the lower surface of the large-diameter portion 8c and the upper surface of the upper mold 2b and the bolts 21 are screwed in. The male threaded portion of the bolts 21 and the female threaded portion of the screw holes for the bolts 21 formed in the upper platen 15 are pressed against each other in the axial direction by the restoration force of the heat insulation ring 25. Thus, the heat insulation ring 25 also functions as a loosening prevention material for the bolts 21.

### (Heat Insulation Layer 9)

As shown in FIGS. 3 and 5, the tip portion 8a of the injection machine 8 is provided with the injection port 6 for ejecting the coating composition 4 and the tip valve portion 7d of the opening/closing valve 7 for opening and closing the injection port 6. The tip portion 8a of the injection machine 8 has an outer circumferential surface 8x inserted into the tip hole portion 11a of the mounting hole 11 formed in the upper mold 2b, and the tip surface 8y provided with the injection port 6. A step surface 8z having a slightly smaller diameter is formed on the outer circumferential surface 8x. The heat insulation layer 9 is provided on the step surface 8z so as to contact the tip hole portion 11a of the mounting hole 11. As for the heat insulation layer 9, a material having a thermal conductivity lower than that of the material of the tip portion 8a of the injection machine 8 is used. Thus, the heat transmitted from the upper mold 2b to the tip portion 8a of the injection machine 8 is suppressed, and the heat received by the coating composition 4 (thermosetting liquid coating agent) from the upper mold 2b in the vicinity of the injection port 6 arranged at the tip portion 8a of the injection machine 8 and the tip valve portion 7d of the opening/closing valve 7 is reduced. Because of this, the curing reaction of the coating composition 4 is suppressed in the vicinity of the injection port 6 of the injection machine 8 and the tip valve portion 7d of the opening/closing valve 7. Namely, the curing reaction of the coating composition 4 before injection (immediately before injection) is suppressed. Thus, a situation where the cured coating composition 4 becomes contamination (impurities, foreign matter) and is injected into the coating gap 13 is prevented and a stable injection state can be achieved.

### (Ceramics as Material of Heat Insulation Layer 9)

The thermal conductivity of the heat insulation layer 9 shown in FIGS. 3 and 5 is lower than the thermal conductivity of the material of the tip portion 8a of the injection machine 8 and lower than the thermal conductivity of the material of the mold 2 (upper mold 2b, lower mold 2a). For example, when the material of the injection machine 8 including the tip portion 8a and the material of the upper mold 2b and lower mold 2a are iron-based metals (e.g., steel, cast iron), ceramics having a thermal conductivity lower than that of the iron-based metals is used for the material of the heat insulation layer 9. As for an example of the ceramics, zirconia, steatite, cordierite, forsterite, yttria, cermet, silicon nitride and alumina can be listed. For example, the thermal conductivity of zirconia alone is 3 W/m-K, which is about 1/10 of the thermal conductivity (25-30 W/m-K) of the iron-based metals (e.g., steel, cast iron). Therefore, when zirconia is used as the material of the heat insulation layer 9, the heat input from the upper mold 2b to the tip portion 8a of the injection machine 8 can be reduced to about 1/10 compared to when the heat insulation layer 9 is not present (when the tip hole portion 11a of the mounting hole 11 formed in the upper mold 2b and the tip portion 8a of the injection machine 8 are in direct contact).

It can be also considered that GFRP, which is glass fiber with epoxy resin or phenolic resin or the like added, is used instead of the ceramics as the material of the heat insulation layer 9 shown in FIGS. 3 and 5. The thermal conductivity of GFRP is 0.5-1.0 W/m-K, which is extremely low compared to the thermal conductivity of the iron-based metals (25-30 W/m-K), and is advantageous in terms of the heat insulation compared to the ceramics. However, when GFRP is used for the heat insulation layer 9, considering the adhesion with the coating composition 4 ejected from the injection port 6 to the coating agent reservoir portion 26 below, GFRP has fine irregularities on the surface due to glass fibers and has a large contact area with the coating composition and a wedge effect occurs. Thus, the coating composition 4 ejected from the injection port 6 to the coating agent reservoir portion 26 easily adheres to the end surface of the heat insulation layer 9 made of GFRP. As a result, after the injection of the coating composition 4 into the coating gap 13 is completed as shown in FIG. 8, when the lower mold 2a is separated from the upper mold 2b to take out the molding base material 3 (product) coated with the coating composition 4, the coating composition 4 in the coating agent reservoir portion 26 adheres to the end surface of the heat insulation layer 9 made of GFRP, and mold release of the product may become difficult. Therefore, it is not appropriate to use GFRP as the material of the heat insulation layer 9.

It can be also considered that olefin-based resins such as polypropylene/polyethylene or fluorine-based resins such as Teflon (registered trademark) are used as the material of the heat insulation layer 9 shown in FIG. 8 since they are chemically difficult to adhere to the coating composition 4 ejected from the injection port 6 to the coating agent reservoir portion 26 below. However, the olefin-based resins cannot be adopted for the heat insulation layer 9 because the heat resistance is low. Namely, the coating composition 4 (thermosetting liquid coating agent) ejected from the injection port 6 to the coating agent reservoir portion 26 is at a temperature (e.g., about 100° C.) for appropriately curing the thermosetting coating agent. Considering the above described temperature, it is not advisable to adopt the olefin-based resins with low heat resistance for the heat insulation layer 9. In addition, Teflon (registered trademark) has insufficient rigidity. Thus, it is difficult to obtain processing accuracy of several microns. If Teflon (registered trademark) is adopted for the heat insulation layer 9, the leakage of the coating composition cannot be prevented. Namely, the heat insulation layer 9 also functions as a packing to prevent the coating composition 4 ejected from the injection port 6 of the tip portion 8a of the injection machine 8 to the coating agent reservoir portion 26 from leaking upward from between the tip portion 8a and the tip hole portion 11a. However, Teflon (registered trademark) has insufficient rigidity and it is difficult to obtain the necessary processing accuracy and Teflon (registered trademark) may not function appropriately as a packing. Thus, it is not advisable to adopt Teflon (registered trademark) for the heat insulation layer 9. Based on the above described considerations, the ceramics is used as the material of the heat insulation layer 9 in the present embodiment.

### (Ceramic Thermal Spray Layer as Heat Insulation Material 9)

The heat insulation layer 9 shown in FIGS. 3 and 5 is composed of a ceramic thermal spray layer obtained by thermally spraying ceramics such as zirconia as described above. The ceramic thermal spray layer 9 is formed by thermally spraying ceramics such as zirconia onto the step surface 8z of the outer circumferential surface 8x of the tip portion 8a of the injection machine 8 to a thickness slightly thicker than the specified dimension (hole diameter of the tip hole portion 11a of the mounting hole 11) and then polishing (cutting) to the specified dimension. Because of this, the thickness of the heat insulation layer 9 (ceramic thermal spray layer) to be formed can be as thin as possible. In the present embodiment, the thickness of the ceramic thermal spray layer 9 is approximately 0.3 mm.

On the other hand, it can be also considered that a ceramic sleeve is formed and the ceramic sleeve is attached to the tip portion 8a of the injection machine 8 to form the heat insulation layer 9. However, the thickness of the ceramic sleeve should be made thick to a certain extent due to strength and rigidity problems. Thus, the thickness of the ceramic sleeve as the heat insulation layer 9 becomes much thicker compared to the ceramic thermal spray layer. As a result, when the tip portion 8a of the injection machine 8 equipped with the ceramic sleeve is inserted into the tip hole portion 11a of the mounting hole 11 formed in the upper mold 2b, the hole diameter of the tip hole portion 11a becomes large and the volume of the coating agent reservoir portion 26 increases. Thus, the coating composition 4 that cures in the coating agent reservoir portion 26 becomes a lump and is discarded and the material yield decreases.

In the present embodiment, the heat insulation layer 9 is made by the ceramic thermal spray layer. Thus, the inner diameter of the tip hole portion 11a of the mounting hole 11 formed for inserting the tip portion 8a of the injection machine 8 into the upper mold 2b can be made as small as possible compared to the case of using the ceramic sleeve. Therefore, the volume of the coating agent reservoir portion 26 partitioned by the tip surface 8y (lower surface) of the tip portion 8a of the injection machine 8, the inner circumferential surface of the tip hole portion 11a of the mounting hole 11 and the lower mold 2a can be reduced. The coating agent reservoir portion 26 is connected to the runner groove 18, and the coating composition 4 that cures in the coating agent reservoir portion 26 is removed (cut off) from the molding base material 3 (product) coated with the coating composition 4 together with the runner that cured in the runner groove 18 in a subsequent process. Therefore, since the volume of the coating agent reservoir portion 26 is reduced, the amount of the coating composition 4 discarded according to the volume of the coating agent reservoir portion 26 is reduced and the material yield of the coating composition 4 is improved.

As shown in FIGS. 3 and 5, in the present embodiment, since the heat insulation layer 9 (ceramic thermal spray layer) is formed on the step surface 8z that is one size smaller than the outer circumferential surface 8x of the tip portion 8a of the injection machine 8, the inner diameter of the tip hole portion 11a of the mounting hole 11 can be reduced by the dimension of the step between the step surface 8z and the outer circumferential surface 8x compared to when the ceramic thermal spray layer 9 is formed directly on the outer circumferential surface 8x of the tip portion 8a of the injection machine 8 (when the step surface 8z does not exist). Because of this, the volume of the coating agent reservoir portion 26 is reduced and the amount of the coating composition 4 discarded according to the volume of the coating agent reservoir portion 26 is reduced. Thus, the material yield of the coating composition 4 is improved.

### (Measuring Cylinder 27, Piston 28)

As shown in FIG. 5, a measuring cylinder 27 for containing a predetermined amount of the coating composition 4 is formed inside the injection machine 8. The measuring cylinder 27 is formed inside the large-diameter portion 8c of the injection machine 8. The measuring cylinder 27 is positioned at the location that is least affected by the heat from the upper mold 2b due to the above described heat insulation layer 9, heat insulation ring 25, gap 22 (air heat insulation layer) and gap 24 (air heat insulation layer) inside the injection machine 8. In the present embodiment, the measuring cylinder 27 is positioned above the upper surface of the upper mold 2b and above the heat insulation ring 25. A piston 28 is provided inside the measuring cylinder 27 so as to be movable in the axial direction (up-down direction). The piston 28 includes a piston main body portion 28a having a diameter that slides in the measuring cylinder 27, and a piston protruding portion 28b provided on the portion that protrudes from the measuring cylinder 27 located at the upper part of the piston main body portion 28a.

### (Injection Port 6)

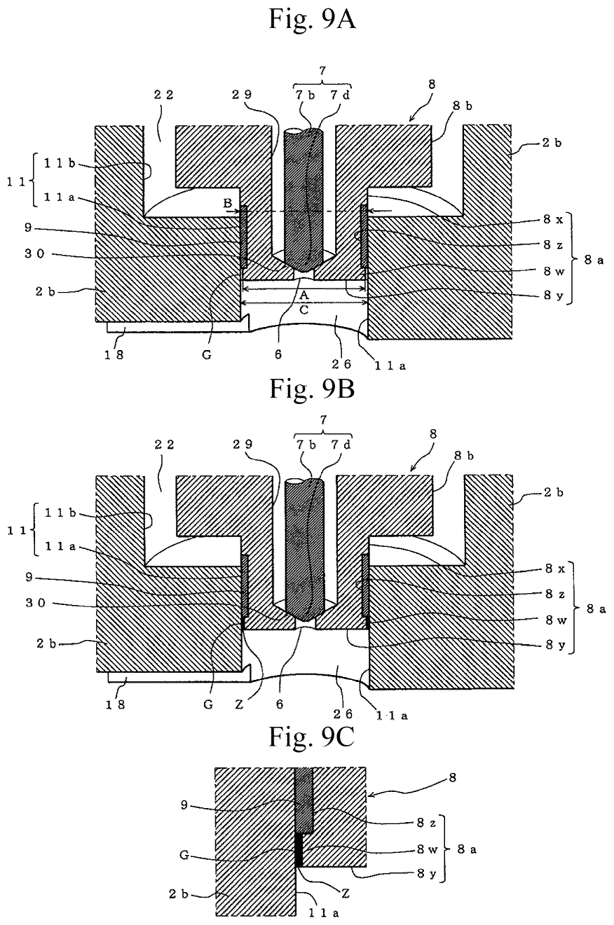

As shown in FIGS. 5 and 9A to 9C, a passage hole 29 having a smaller diameter than the measuring cylinder 27 is formed connecting to the measuring cylinder 27 and extending downward inside the medium-diameter portion 8b and the tip portion 8a of the injection machine 8 shown in FIG. 2. A valve seat 30 having a conical shape is formed at the lower end of the passage hole 29. The injection port 6 is formed at the lower end of the valve seat 30 so as to communicate with the coating agent reservoir portion 26. The injection port 6 is closed when the tip valve portion 7d located at the lower end of the opening/closing valve 7 sits on the valve seat 30. The injection port 6 is opened when the tip valve portion 7d located at the lower end of the opening/closing valve 7 is separated from the valve seat 30. When the valve is opened, the coating composition 4 in the measuring cylinder 27 passes through the passage hole 29 and is injected from the injection port 6 into the coating agent reservoir portion 26. Then, the coating composition 4 is injected from the coating agent reservoir portion 26 into the coating gap 13 through the runner groove 18.

### (Supply Passage 32)

As shown in FIG. 5, a supply port 31 for supplying the coating composition 4 to the measuring cylinder 27 is provided at a side portion of the large-diameter portion 8c of the injection machine 8 so as to be connected to the measuring cylinder 27. A supply passage 32 for supplying the coating composition 4 to the measuring cylinder 27 is connected to the supply port 31. The supply passage 32 is inserted into a hole formed inside the upper platen 15 with a diameter larger than the outer diameter of the supply passage 32. A gap 33 is formed between the hole and the supply passage 32. The gap 33 serves as an air heat insulation layer to suppress the heat of the upper platen 15 from being transmitted to the coating composition 4 flowing inside the supply passage 32.

### (Supply Valve 34)

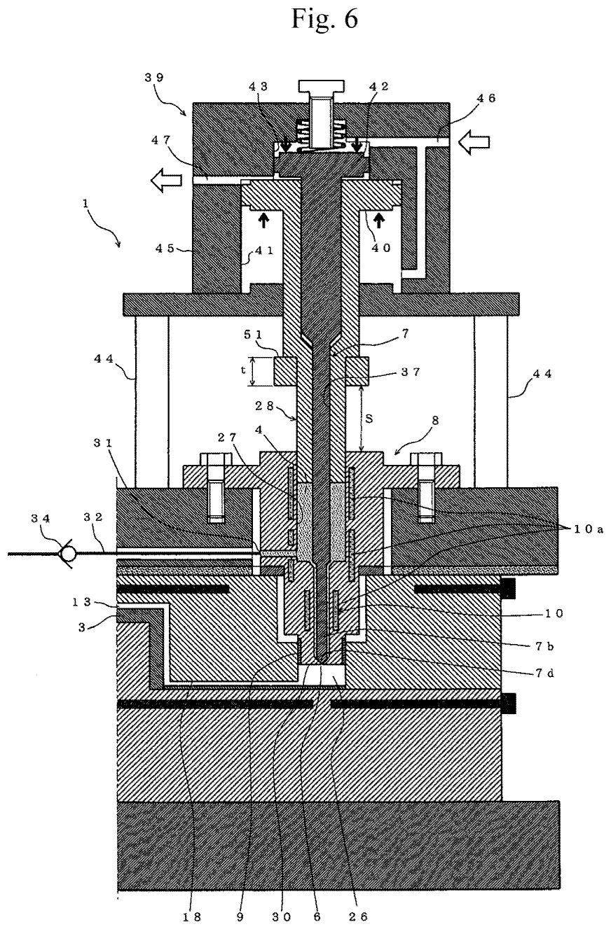

The supply passage 32 shown in FIG. 2 is provided with a supply valve 34 that opens the supply passage 32 when the piston 28 moves in the suction direction (upward) to expand the volume of the measuring cylinder 27 as shown in FIGS. 5 to 6 and closes the supply passage 32 when the piston 28 moves in the discharge direction (downward) to reduce the volume of the measuring cylinder 27 as shown in FIGS. 7 to 8. (Note that FIG. 6 shows a state that the filling of the measuring cylinder 27 with the coating composition 4 is completed and the supply valve 34 is closed.) In the present embodiment, a check valve that allows the coating composition 4 to flow from the supply passage 32 to the measuring cylinder 27 while preventing the coating composition 4 from flowing from the measuring cylinder 27 to the supply passage 32 is used as the supply valve 34. However, the supply valve 34 may be a control valve that opens and closes the supply passage 32 as described above. As shown in FIG. 2, a coating composition tank 35 containing the coating composition 4 is connected to the upstream side of the supply valve 34 via a piping 36.

### (Opening/Closing Valve 7)

As shown in FIG. 5, the piston 28 has a hole 37 formed through the piston 28 in the axial direction (up-down direction). The opening/closing valve 7 having an elongated shape in the up-down direction is mounted in the hole 37 so as to be slidable in the axial direction. The opening/closing valve 7 includes a medium-diameter portion 7a having a diameter that slides in the hole 37, a tip portion 7b integrally provided at the lower part of the medium-diameter portion 7a, and a large-diameter portion 7c integrally provided at the upper part of the medium-diameter portion 7a. The tip portion 7b is accommodated in the passage hole 29 with a predetermined gap in the radial direction. The tip portion 7b includes a tip valve portion 7d formed in a conical shape at a lower end so as to sit on the valve seat 30. The large-diameter portion 7c has a diameter that slides in a hole 38 formed axially inside the piston protruding portion 28b. An upper part of the large-diameter portion 7c protrudes upward from the piston protruding portion 28b. The above described opening/closing valve 7 is located at a valve opening position where the tip valve portion 7d separates from the valve seat 30 to open the injection port 6 when the opening/closing valve 7 ascends. The opening/closing valve 7 is located at a valve closing position where the tip valve portion 7d sits on the valve seat 30 to close the injection port 6 when the opening/closing valve 7 descends.

### (Actuator 39)

The piston 28 and opening/closing valve 7 shown in FIG. 5 are appropriately moved up and down by an actuator 39. As shown in FIGS. 5 to 6, the actuator 39 moves the opening/closing valve 7 downward to the valve closing position and moves the piston 28 upward in the suction direction. Thus, the coating composition 4 in the coating composition tank 35 shown in FIG. 2 is introduced from the supply port 31 into the measuring cylinder 27 through the piping 36 to fill the measuring cylinder 27 with a predetermined amount of the coating composition 4. Then, as shown in FIGS. 7 to 8, the actuator 39 moves the opening/closing valve 7 upward to the valve opening position and moves the piston 28 downward in the discharge direction to inject the predetermined amount of the coating composition 4 in the measuring cylinder 27 from the injection port 6 into the coating agent reservoir portion 26.

As shown in FIG. 5, the actuator 39 includes: a piston operating flange 40 formed on a portion (piston protruding portion 28b) of the piston 28 that protrudes from the measuring cylinder 27 for moving the piston 28 in the axial direction of the measuring cylinder 27; a piston operating cylinder 41 formed to accommodate the piston operating flange 40 movably along the axial direction of the measuring cylinder 27; an opening/closing valve operating flange 42 formed on a portion (opening/closing valve protruding portion 7e) of the large-diameter portion 7c of the opening/closing valve 7 that protrudes from the piston 28 for moving the opening/closing valve 7 in the axial direction of the piston 28; and an opening/closing valve operating cylinder 43 formed connected to the piston operating cylinder 41 to accommodate the opening/closing valve operating flange 42 movably along the axial direction of the piston 28.

As shown in FIG. 5, the piston operating cylinder 41 and the opening/closing valve operating cylinder 43 are respectively formed inside a cylinder block 45 attached to the upper platen 15 via support columns 44. The cylinder block 45 is formed with: a first passage 46 for applying the fluid pressure to the upper surface of the opening/closing valve operating flange 42 and the lower surface of the piston operating flange 40; and a second passage 47 for applying the fluid pressure to the lower surface of the opening/closing valve operating flange 42 and the upper surface of the piston operating flange 40. The first passage 46 includes: a passage 46a connecting a hole formed on one side surface of the cylinder block 45 and a portion of the opening/closing valve operating cylinder 43 above the opening/closing valve operating flange 42; and a passage 46b connecting an intermediate portion of the passage 46a and a portion of the piston operating cylinder 41 below the piston operating flange 40. The second passage 47 connects a hole formed on the other side surface of the cylinder block 45 and a portion of the piston operating cylinder 41 above the piston operating flange 40.

In addition, the actuator 39 includes a fluid pressure switching means 48 (show in FIG. 2) to switch between a measuring mode and an injection mode. In the measurement mode, as shown in FIGS. 5 to 6, fluid (e.g., air, water, oil) is supplied to the first passage 46 to apply the fluid pressure to the upper surface of the opening/closing valve operating flange 42 and the lower surface of the piston operating flange 40 so that the opening/closing valve 7 closes the injection port 6 and the piston 28 moves in the suction direction. In the injection mode, as shown in FIG. 7 to FIG. 8, the fluid is supplied to the second passage 47 to apply the fluid pressure to the lower surface of the opening/closing valve operating flange 42 and the upper surface of the piston operating flange 40 so that the opening/closing valve 7 opens the injection port 6 and the piston 28 moves in the discharge direction.

### (Fluid Pressure Switching Means 48)

As shown in FIG. 2, the fluid pressure switching means 48 includes: a switching valve 49 connected to the first passage 46 and the second passage 47; a tank T (e.g., air tank, water tank, oil tank) containing fluid (e.g., air, water, oil) at a predetermined pressure to supply the fluid pressure (e.g., air pressure, water pressure, oil pressure); a pump P for pressurizing and supplying the fluid to the tank T; and a controller C for appropriately switching the switching valve 49. In the present embodiment, air is used as the fluid and an electromagnetic solenoid valve is used as the switching valve 49 as an example.

In the electromagnetic solenoid valve (switching valve 49) shown in FIG. 2, when the electricity is not supplied from the controller C to a solenoid 49a, a box is pushed rightward by a spring 49b and a parallel circuit functions. As a result, the air in the tank T is supplied to the first passage 46, and the air in the second passage 47 is exhausted from an exhaust silencer 50. Consequently, the opening/closing valve 7 descends to the valve closing position and the piston 28 moves upward (suction direction), resulting in the measuring mode as shown in FIGS. 5 to 6.

On the other hand, when the electricity is supplied to the solenoid 49a from the controller C shown in FIG. 2, the solenoid 49a is excited and the box is moved leftward and a cross circuit functions. As a result, the air in the tank T is supplied to the second passage 47, and the air in the first passage 46 is exhausted from the exhaust silencer 50. Consequently, the opening/closing valve 7 ascends to the valve opening position and the piston 28 moves downward (discharge direction), resulting in the injection mode as shown in FIGS. 7 to 8.

### (Cooling Mechanism 10)

As shown in FIGS. 4A and 4B, the cooling mechanism 10 is provided inside the injection machine 8 to prevent the coating composition 4 (thermosetting liquid coating agent) inside the injection machine 8 from curing. As shown in FIGS. 4B and 5, the cooling mechanism 10 consists of a cooling water passage 10a formed to surround the measuring cylinder 27 and the passage hole 29. The cooling water passage 10a is formed in a double helical shape surrounding the measuring cylinder 27 and the passage hole 29. The cooling water introduced from an inlet 10b formed on the left side of the upper part of the injection machine 8 descends counterclockwise when viewed from above, is turned back at the lower part of the injection machine 8, ascends clockwise, and is discharged from an outlet 10c formed on the right side of the upper part of the injection machine 8. The injection machine 8 having such a complex-shaped cooling water passage 10a is manufactured by metal 3D printing, lost-wax casting, or the like. The cooling water flowing through the cooling water passage 10a can suppress the coating composition 4 contained in the measuring cylinder 27 and the passage hole 29 from being excessively heated by the heat from the upper mold 2b and progressing in curing reaction.

### (Start of Measurement)

When introducing a predetermined amount of the coating composition 4 to the injection machine 8 of the in-mold coating injection device 1 shown in FIG. 2, the fluid (air) in the tank (air tank) T is first supplied to the first passage 46 as shown in FIG. 5. Then, the opening/closing valve 7 descends to the valve closing position and the piston 28 ascends. Consequently, the inside of the measuring cylinder 27 becomes a negative pressure and the coating composition 4 in the coating composition tank 35 shown in FIG. 2 is introduced into the measuring cylinder 27 via the supply valve 34 (check valve). Here, if the tip valve portion 7d of the opening/closing valve 7 separates from the valve seat 30, the coating composition 4 would leak from the injection port 6. Thus, a leak prevention spring 48a is provided on the ceiling surface of the cylinder block 45 above the opening/closing valve operating flange 42 to bias the opening/closing valve 7 downward and press the tip valve portion 7d against the valve seat 30. Therefore, even if the actuator 39 malfunctions or emergency stops and becomes uncontrollable, the coating composition 4 inside the injection machine 8 will not leak into the mold 2. The fluid (air) above the piston operating flange 40 in the piston operating cylinder 41 is discharged from the second passage 47 as the piston operating flange 40 ascends and is exhausted from the exhaust silencer 50.

### (Completion of Measurement)

As shown in FIG. 6, the piston operating flange 40 of the piston 28 contacts the ceiling surface of the piston operating cylinder 41. Thus, the piston 28 reaches the top dead center, and a predetermined amount of the coating composition 4 is stored in the measuring cylinder 27. As described above, the measurement is completed.

### (Start of Injection)

Then, the fluid (air) in the air tank T shown in FIG. 2 is supplied to the second passage 47 as shown in FIG. 7 for injecting a predetermined amount of the coating composition 4 from the injection port 6 into the coating agent reservoir portion 26. Thus, the opening/closing valve 7 ascends to open the injection port 6, and the piston 28 descends to reduce the volume of the measuring cylinder 27. Because of this, the coating composition 4 in the measuring cylinder 27 is injected from the injection port 6 into the coating agent reservoir portion 26. At this time, the supply valve 34 (check valve) prevents the coating composition 4 in the measuring cylinder 27 from flowing back to the coating composition tank 35 side shown in FIG. 2. Note that the fluid below the piston operating flange 40 in the piston operating cylinder 41 is discharged from the first passage 46 as the piston operating flange 40 descends, and the fluid above the opening/closing valve operating flange 42 in the opening/closing valve operating cylinder 43 is discharged from the first passage 46 as the opening/closing valve operating flange 42 ascends.

### (Completion of Injection)

As shown in FIG. 8, the lower surface of a stroke adjustment ring 51 provided on the piston 28 contacts the upper surface of the injection machine 8. Thus, the piston 28 reaches the bottom dead center. As described above, the injection of the predetermined amount of the coating composition 4 is completed. A stroke S (shown in FIG. 6) from the top dead center to the bottom dead center can be adjusted by appropriately changing a thickness t of the stroke adjustment ring 51. Thus, the injection amount of the coating composition 4 can be adjusted. In addition, the tip valve portion 7d of the opening/closing valve 7 is pressed against the valve seat 30 with the leak prevention spring 48a. Thus, the leakage of the coating composition 4 inside the injection machine 8 into the coating agent reservoir portion 26 in the mold 2 can be prevented.

### (Operations and Effects)

The in-mold coating injection device 1 and the in-mold coating injection method using the same according to the present embodiment can exhibit the following effects.

As shown in FIG. 2, the in-mold coating injection device 1 according to the present embodiment is configured to inject a predetermined amount of the coating composition 4 (thermosetting liquid coating agent) as a coating agent into the coating gap 13 between the outer surface of the molding base material 3 held inside the mold 2 (upper mold 2b, lower mold 2a) heated by the heating mechanism 19 and the inner surface of the cavity 14 of the upper mold 2b, the predetermined amount corresponding to the volume of the space by the coating gap 13.

As shown in FIG. 5, the in-mold coating injection device 1 includes the injection machine 8 having the injection port 6 and the tip valve portion 7d of the opening/closing valve 7 for opening and closing the injection port 6 at the tip portion 8a for injecting the coating composition 4 ejected from the injection port 6 into the coating gap 13 between the outer surface of the base material 3 and the inner surface of the cavity 14 of the upper mold 2b; and the heat insulation layer 9 provided between the tip portion 8a of the injection machine 8 and the tip hole portion 11a of the mounting hole 11 of the upper mold 2b and made of the material (ceramics) having the thermal conductivity lower than that of the material (e.g., steel, cast iron) of the tip portion 8a.

Therefore, as shown in FIG. 2, the heat of the heating mechanism 19 provided in the upper mold 2b to cure the coating composition 4 (thermosetting liquid coating agent) injected into the coating gap 13 is transmitted to the tip portion 8a of the injection machine 8 via the heat insulation layer 9. Thus, the heat transfer from the upper mold 2b to the tip portion 8a of the injection machine 8 is suppressed. As shown in FIGS. 7 and 8, the heat received by the coating composition 4 (thermosetting liquid coating agent) from the upper mold 2b in the vicinity of the injection port 6 arranged at the tip portion 8a and the tip valve portion 7d of the opening/closing valve 7 for opening and closing the injection port 6 can be reduced.

As a result, in FIGS. 7 and 8, the curing reaction of the coating composition 4 in the vicinity of the injection port 6 and the tip valve portion 7d of the opening/closing valve 7 for opening and closing the injection port 6 of the injection machine 8 (i.e., curing reaction of the coating composition 4 immediately before injection into the coating gap 13) is suppressed. Thus, the contamination (impurities, foreign matter) caused by curing of the coating composition 4, the blockage of the injection port 6, the adhesion between the tip valve portion 7d of the opening/closing valve 7 and the valve seat 30, the adhesion between the tip portion 7b of the opening/closing valve 7 and the passage hole 29 can be prevented, for example. Consequently, a stable injection state can be achieved.

In addition, as shown in FIGS. 3 and 4, the in-mold coating injection device 1 is provided with the cooling mechanism 10 in the injection machine 8 to cool the coating composition 4 inside the injection machine 8 to prevent the coating composition 4 (thermosetting liquid coating agent) inside the injection machine 8 from curing. Therefore, as shown in FIG. 2, even if a part of the heat of the upper mold 2b heated by the heating mechanism 19 provided to cure the coating composition 4 injected into the coating gap 13 passes through the heat insulation layer 9 and is transmitted to the tip portion 8a of the injection machine 8, the coating composition 4 (thermosetting liquid coating agent) in the vicinity of the injection port 6 of the tip portion 8a of the injection machine 8 and the tip valve portion 7d of the opening/closing valve 7 for opening and closing the injection port 6 can be maintained at a temperature that can exhibit appropriate curing reaction.

### (Modification)

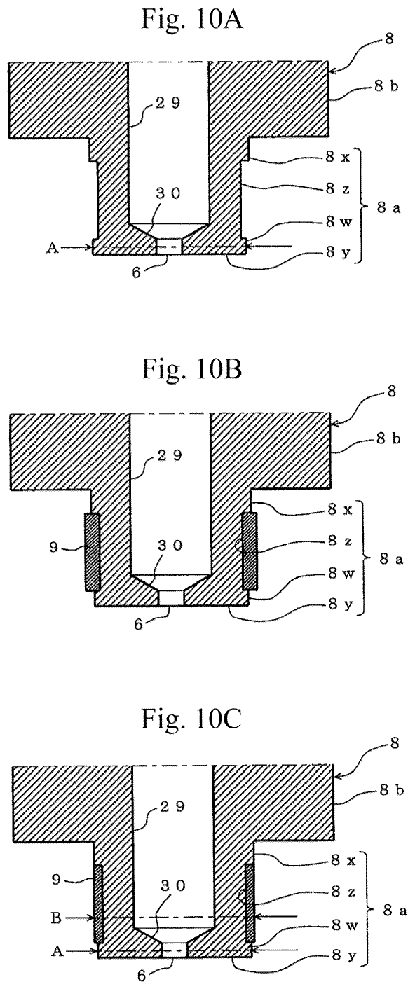

It can be considered that ceramics is thermally sprayed onto the step surface 8z of the outer circumferential surface 8x of the tip portion 8a so that the heat insulation layer 9 (ceramic thermal spray layer) becomes porous to enhance the heat insulation of the heat insulation layer 9 provided on the step surface 8z of the outer circumferential surface 8x of the tip portion 8a of the injection machine 8 shown in FIG. 8. Because of this, the thermal conductivity of the heat insulation layer 9 (ceramic thermal spray layer) can be reduced to 1 W/m-K or less. Thus, the heat input from the upper mold 2b to the tip portion 8a of the injection machine 8 can be greatly reduced. However, when the heat insulation layer 9 (ceramic thermal spray layer) is made porous, a part of the coating composition 4 (thermosetting liquid coating agent) ejected from the injection port 6 of the injection machine 8 to the coating agent reservoir portion 26 may contact the end surface of the heat insulation layer 9 (ceramic thermal spray layer) and bite in, making mold release difficult. A modification that resolves the above described problem will be explained using FIGS. 9A to 9C and 10A to 10C.

FIG. 9A shows a cross-sectional view of the tip portion 8a of the injection machine 8 of the in-mold coating injection device 1 according to a modification of the present invention. The in-mold coating injection device 1 according to the modification has basically the same configuration as the in-mold coating injection device 1 according to the embodiment explained above using FIGS. 2 to 8. Thus, the same reference numerals are assigned to the same components to omit explanations and differences will be explained.

As shown in FIG. 9A, on the step surface 8z of the outer circumferential surface 8x of the tip portion 8a of the injection machine 8 of the in-mold coating injection device 1 according to the modification, a flange portion 8w is provided positioned closer to the tip surface 8y side than the heat insulation layer 9 (ceramic thermal spray layer) provided on the step surface 8z. An outer diameter A of an edge of the flange portion 8w is smaller than an outer diameter B of a surface of the heat insulation layer 9. The outer diameter B of the surface of the heat insulation layer 9 is equal to a hole diameter C of the tip hole portion 11a of the mounting hole 11. Therefore, a gap G is formed between the edge of the flange portion 8w and the tip hole portion 11a of the mounting hole 11 of the upper mold 2b.

FIGS. 10A, 10B and 10C show manufacturing processes of the flange portion 8w of the tip portion 8a and the heat insulation layer 9. First, as shown in FIG. 10A, a step surface 8z having a smaller diameter than the outer circumferential surface 8x and a flange portion 8w having a larger diameter than the step surface 8z and smaller diameter than the outer circumferential surface 8x are formed on the outer circumferential surface 8x of the tip portion 8a of the injection machine 8 by a cutting process using a lathe or the like. Then, as shown in FIG. 10B, ceramics (e.g., zirconia) is thermally sprayed onto the step surface 8z to a diameter larger than the outer circumferential surface 8x. After that, as shown in FIG. 10C, the thermally sprayed ceramics is polished (cut) to be flush with the outer circumferential surface 8x. Thus, the ceramic thermal spray layer 9 is completed as a heat insulation layer.

As shown in FIG. 9A, the outer diameter B of the ceramic thermal spray layer 9 is the same as the hole diameter C of the tip hole portion 11a of the mounting hole 11, and the outer diameter A of the edge of the flange portion 8w is slightly smaller than the hole diameter C of the tip hole portion 11a of the mounting hole 11. In the present embodiment, the outer diameter B of the ceramic thermal spray layer 9 is 10.000 mm, the hole diameter C of the tip hole portion 11a of the mounting hole 11 is 10.000 mm and the outer diameter A of the edge of the flange portion 8w is 9.994 mm. A slight gap G of 0.006 mm (6 μm) is formed between the edge of the flange portion 8w and the inner circumferential surface of the tip hole portion 11a of the mounting hole 11. Note that the gap G is not limited to 6 μm and may be in the range of 1-9 μm.

### (Operations and Effects of Modification)

When the coating composition 4 (thermosetting liquid coating agent) is ejected from the injection port 6 of the tip portion 8a of the injection machine 8 shown in FIG. 9A to the coating agent reservoir portion 26 using the injection machine 8 according to the modification shown in FIG. 9A to inject the coating composition 4 (thermosetting liquid coating agent) into the coating gap 13 between the outer surface of the molding base material 3 and the inner surface of the cavity 14 of the upper mold 2b shown in FIG. 2, a part of the ejected coating composition 4 (thermosetting liquid coating agent) enters the gap G between the tip hole portion 11a of the mounting hole 11 of the upper mold 2b and the edge of the flange portion 8w of the injection machine 8, and the coating composition 4 (thermosetting liquid coating agent) entered the gap G cures due to the heat from the upper mold 2b as shown in FIG. 9B and FIG. 9C which is a partially enlarged view of FIG. 9B. The coating composition 4 (thermosetting liquid coating agent) that cured in the above described way functions as a plug Z that blocks the gap G. Thus, the coating composition 4 (thermosetting liquid coating agent) ejected from the injection port 6 is prevented from penetrating into the heat insulation layer 9 (ceramic thermal spray layer) through the gap G.

Therefore, for example, even when the ceramics is thermally sprayed onto the step surface 8z of the tip portion 8a of the injection machine 8 so that the ceramic thermal spray layer 9 becomes porous in order to enhance the heat insulation of the heat insulation layer 9 (ceramic thermal spray layer), the situation where the coating composition 4 (thermosetting liquid coating agent) ejected from the injection port 6 of the injection machine 8 to the coating agent reservoir portion 26 contacts and bites into the end surface of the heat insulation layer 9 (ceramic thermal spray layer) through the gap G shown in FIG. 9A can be avoided. Thus, the mold release is facilitated. In addition, the deterioration of the ceramic thermal spray layer 9 due to the coating composition 4 entering from the end surface of the heat insulation layer 9 (ceramic thermal spray layer) and entering the interior can be avoided. Furthermore, when the tip portion 8a of the injection machine 8 is inserted into the tip hole portion 11a of the mounting hole 11 provided in the upper mold 2b, the flange portion 8w functions as a cover (protective member) that protects the corner at the lower end of the heat insulation layer 9 (ceramic thermal spray layer) for preventing the damage to the corner at the lower end of the heat insulation layer 9 (ceramic thermal spray layer) by hitting the edge of the tip hole portion 11a.

The preferable embodiments of the present invention are explained above with reference to the drawings. Of course, the present invention is not limited to the above described embodiments. It goes without saying that various variation examples and modified examples within the range described in the claims are included in the technical scope of the present invention.

### INDUSTRIAL APPLICABILITY

The present invention can be used for the in-mold coat injection device and the in-mold coat injection method using the same for injecting the thermosetting liquid coating agent into the coating gap formed between the molding base material held inside the mold which is heated and the inner surface of the mold.

### DESCRIPTION OF THE REFERENCE NUMERALS

1: in-mold coat injection device, 2: mold, 2a: lower mold, 2b: upper mold, 3: molding base material, 4: thermosetting liquid coating agent (coating composition), 6: injection port, 7: opening/closing valve, 7d: tip valve portion, 8: injection machine, 8a: tip portion, 8b: medium-diameter portion, 8c: large-diameter portion, 8x: outer circumferential surface, 8y: tip surface, 8z: step surface, 8w: flange portion, 9: heat insulation layer (ceramic thermal spray layer), 10: cooling mechanism, 10a: coolant passage, 11: mounting hole, 11a: tip hole portion, 12: core, 13: coating gap, 14: cavity, 26: coating agent reservoir portion, G: gap, A: outer diameter of edge portion of flange portion 8w, B: outer diameter of surface of heat insulation layer 9, Z: plug of cured coating composition 4 entered in gap G

1. An in-mold coat injection device for injecting a thermosetting liquid coating agent between an outer surface of a molding base material held inside a mold which is heated and an inner surface of the mold, the in-mold coat injection device comprising:
an injection machine having an injection port and an opening/closing valve for opening and closing the injection port at a tip portion, the injection machine being configured to inject the thermosetting liquid coating agent ejected from the injection port between the outer surface of the molding base material and the inner surface of the mold; and
a heat insulation layer provided between the tip portion of the injection machine and the mold, the heat insulation layer being made of a material having a thermal conductivity lower than that of a material of the tip portion, wherein
the injection machine is provided with a cooling mechanism to prevent the thermosetting liquid coating agent inside the injection machine from curing,
the tip portion of the injection machine has an outer circumferential surface configured to be inserted into a mounting hole formed in the mold and a tip surface provided with the injection port,
the heat insulation layer is provided on the outer circumferential surface of the tip portion so as to contact an inner circumferential surface of the mounting hole,
a flange portion is provided on the outer circumferential surface of the tip portion of the injection machine so as to be positioned closer to the tip surface than the heat insulation layer provided on the outer circumferential surface,
an outer diameter of an edge portion of the flange portion is smaller than an outer diameter of a surface of the heat insulation layer, and
a gap is formed between the edge portion of the flange portion and the mounting hole of the mold.

2. The in-mold coating injection device according to claim 1, wherein
a thermal conductivity of the heat insulation layer is lower than a thermal conductivity of the mold.

3. The in-mold coating injection device according to claim 1, wherein
the heat insulation layer is a thermal spray layer.

4. The in-mold coating injection device according to claim 3, wherein
the thermal spray layer is a ceramic thermal spray layer formed by thermally spraying ceramics.

5. The in-mold coating injection device according to claim 1, wherein
the heat insulation layer is porous.

6. An in-mold coating injection method for injecting the thermosetting liquid coating agent between the outer surface of the molding base material and the inner surface of the mold using the in-mold coating injection device according to claim 1, wherein
a heat of the mold is transmitted to the tip portion of the injection machine via the heat insulation layer to suppress a heat transfer from the mold to the tip portion of the injection machine, and
a curing reaction of the thermosetting liquid coating agent in a vicinity of the injection port arranged at the tip portion of the injection machine and the opening/closing valve for opening and closing the injection port is suppressed.

7. An in-mold coating injection method for injecting the thermosetting liquid coating agent between the outer surface of the molding base material and the inner surface of the mold using the in-mold coating injection device according to claim 1, wherein
a part of the thermosetting liquid coating agent ejected from the injection port of the injection machine enters the gap between the mounting hole of the mold and the edge portion of the flange portion of the injection machine, and
the thermosetting liquid coating agent entered the gap cures due to a heat from the mold for preventing the thermosetting liquid coating agent ejected from the injection port from penetrating into the heat insulation layer through the gap.
